(19) United States
(12) Patent Application Publication
(10) Pub. No.: US 2026/0210471 A1
(43) Pub. Date: Jul. 23, 2026

(54) FLUID LINE COUPLING

(71) Applicants: CONTITECH TECHNO-CHEMIE GMBH, Karben (DE); AFT AUTOMOTIVE GMBH, Greven (DE)

(72) Inventors: Axel Bornemann, Hannover (DE); Jonas Magnus Wilmes, Salzbergen (DE)

(21) Appl. No.: 19/140,208

(22) PCT Filed: Oct. 12, 2023
(86) PCT No.: PCT/EP2023/078362

§ 371 Date: Jun. 17, 2025

(30) Foreign Application Priority Data
Dec. 19, 2022 (DE) 10 2022 133 925.4

(51) Int. Cl. F16L 37/098

(52) U.S. Cl. CPC F16L 37/0985; F16L 37/0982; F16L 2201/10

(57) ABSTRACT

The invention relates to a fluid line coupling (10) for the reversibly detachable connection of fluid lines, with a coupling plug (12), a locking element (30), which comprises at least one locking arm (32a-32d) with at least one locking extension (34) for locking the coupling plug (12) in a locking state of the fluid line coupling (10), a coupling housing (18), wherein the locking element (30) and the coupling plug (12) are arranged at least partially in the coupling housing (18) in the locking state of the fluid line coupling (10), and a locking ring (40), by means of which an unlocking movement (E) of the locking arm (32a-32d) is blocked in the locking state of the fluid line coupling (10).

The invention relates to a fluid line coupling according to the preamble of claim 1.

Fluid line couplings of this type are used in various areas of application, particularly in the automotive industry, to connect fluid lines, for example hoses or pipes for cooling water, lubricants or fuel, to each other in a fluid-conducting manner.

In practice, it has proven to be advantageous if the fluid lines are reversibly detachably connected by means of the fluid line coupling and the fluid line coupling can be unlocked to release the connection of the fluid lines.

For example, a fluid line coupling is known from the publication DE 10 2020 203 433A 1 , in which a coupling plug, which is connected to a first fluid line, is plugged together with a coupling housing, which is connected to a second fluid line, and is locked by means of a locking element so that the fluid lines are securely connected to each other. By moving a locking ring, the lock can be released by means of the locking element so that the coupling plug is released and can be pulled out of the coupling housing.

However, ageing processes and, in particular, the creep behavior of the materials of the fluid line coupling often cause that the unlocking of the fluid line coupling no longer functions properly and the coupling plug remains locked by the locking element despite actuation of the locking ring. As a result, the coupling plug is not released for removal from the coupling housing as intended.

For this reason, disassembly of the fluid line coupling is prevented or at least impaired, which consequently makes repair work and the replacement of fluid line and/or coupling components, for example, more difficult.

The task underlying the invention is therefore to improve the unlocking mechanism of fluid line couplings.

The problem is solved by a fluid line coupling of the type mentioned at the beginning, wherein the locking element has at least one unlocking member, wherein the unlocking movement of the locking arm in an unlocking state of the fluid line coupling can be brought about by an actuation of the at least one unlocking member by means of the locking ring.

The fact that the unlocking movement of the locking arm can be brought about by actuation of the at least one unlocking member by means of the locking ring ensures that reliable unlocking of the fluid line coupling is always possible. As a result, problems caused by faulty unlocking during the disassembly of fluid line couplings are avoided, making repair work on fluid line couplings or fluid lines connected to them easier, for example.

The fluid line coupling is preferably designed as an SAE coupling with standardized geometries. By locking the coupling plug, an axial movement of the coupling plug relative to the coupling housing and/or the locking element can be limited and/or blocked. Preferably, the coupling plug comprises a locking collar, in particular a circumferential locking collar, by means of which the coupling plug can be locked. Preferably, the coupling plug comprises a fluid line receiving area in which a fluid line can be connected to the coupling plug in a fluid-conducting manner. Preferably, the coupling housing comprises a fluid line receiving area in which a fluid line can be connected to the coupling plug in a fluid-conducting manner. Preferably, the fluid line coupling further comprises at least one seal which seals the fluid line coupling in a fluid-tight manner, in particular between the coupling plug and the coupling housing, so that no fluid can escape from the fluid line coupling when a fluid flows through the fluid line coupling.

The locking element can comprise several locking arms. Preferably, the locking element comprises four locking arms. The locking arms are preferably evenly distributed around the circumference of the locking element. Preferably, two locking elements are arranged opposite each other. The locking arms preferably extend in the axial direction of the fluid line coupling. The locking arms each comprise at least one locking extension for locking the coupling plug.

Preferably, the locking extensions prevent the coupling plug from moving out of the coupling housing, as the locking collar of the coupling plug strikes against the locking extensions and axial movement of the coupling plug is consequently limited and/or blocked. Preferably, the coupling housing, the locking element, the locking ring and the coupling plug can be plugged together to form the fluid line coupling. To assemble the fluid line coupling, at least one seal and then the locking element are first inserted into the coupling housing. The locking ring is then pushed over the outside of the coupling housing before the coupling plug is finally pushed into the coupling housing until the coupling plug is locked by means of the locking element arranged inside the coupling housing.

The locking element preferably has an axial opening which can receive the coupling plug. The coupling housing also has an axial opening for receiving the locking element. The inner diameter of the axial opening of the coupling housing can be smaller than the outer diameter of the locking element, wherein an insertion of the locking element into the coupling housing is preferably made possible by elastic deflection of the locking arms. In addition, the coupling housing comprises radial openings through which the locking arms of the locking element can at least partially extend in the assembled state. Preferably, the locking ring can be pushed axially onto the outer circumference of the coupling housing.

The coupling housing preferably has a circumferential support collar, which can serve as a stop for the locking ring and/or on which the locking ring can rest and be axially supported in the assembled state. Preferably, the locking ring has a support part, a spring part and a locking part. With the support part, the locking ring can be supported on the support collar of the coupling plug. The locking part of the locking ring can block the unlocking movement of the locking arm. The spring part enables an axial movement of the locking part and/or the support part relative to each other. Preferably, the coupling housing, the coupling plug, the locking element and/or the locking ring are made of a plastic material. In particular, the coupling housing, the coupling plug, the locking element and/or the locking ring can be injection-molded parts.

In a preferred embodiment of the fluid line coupling according to the invention, the at least one unlocking member is arranged on the locking arm. The at least one unlocking member is preferably arranged on the outside of the locking arm facing the coupling housing and/or the locking ring. The at least one unlocking element is preferably firmly connected to the locking arm, in particular in a material-locking manner. If the locking element comprises several locking arms, an unlocking member can be arranged on several of the locking arms. Preferably, an unlocking member is arranged on at least two opposing locking arms of the locking element. A locking arm can also comprise several unlocking elements.

In another preferred embodiment of the fluid line coupling according to the invention, the at least one unlocking member is designed as a hook-shaped extension, wherein the at least one unlocking member preferably extends at least in sections in the radial direction of the locking element. Preferably, the unlocking member has a curvature, wherein the angle of curvature is preferably between 20 degrees and 160 degrees, particularly preferably between 70 degrees and 120 degrees. Preferably, a first section of the unlocking member extends substantially in the axial direction of the locking arm and a second section of the unlocking member extends substantially in the radial direction of the locking arm. The second section of the unlocking member extending in the radial direction of the locking arm preferably points outwards. Preferably, the second section of the unlocking member extending in the radial direction of the locking arm has an actuating surface by means of which the at least one unlocking member can be actuated by means of the locking ring in order to bring about the unlocking movement of the locking arm.

In a further embodiment of the fluid line coupling according to the invention, the locking ring comprises at least one unlocking extension for actuating the at least one unlocking member of the locking element in the unlocking state of the fluid line coupling. The locking ring can have several unlocking extensions. Preferably, the locking ring has two oppositely arranged unlocking extensions, wherein the at least two oppositely arranged unlocking extensions are preferably set up to actuate at least two oppositely arranged unlocking members of the locking element for bringing about the unlocking movement of the locking arms in the unlocking state of the fluid line coupling. Preferably, the unlocking extensions are arranged on the inside of the locking ring, in particular on the inside of the locking part of the locking ring.

Preferably, the unlocking extensions are hook-shaped, wherein the hook-shaped unlocking extensions preferably extend at an angle in the direction of the spring part of the locking ring and the inside of the locking ring. Preferably, the unlocking extensions are shaped to match the unlocking members of the locking arms. Preferably, the unlocking extensions have an actuating surface by means of which the at least one unlocking member of the locking element can be actuated in order to bring about the unlocking movement of the locking arm. Preferably, the unlocking extensions are firmly connected to the locking ring, in particular to the locking part of the locking ring, in particular in a material-locking manner. During an axial movement of the locking ring, in particular the locking part of the locking ring, the unlocking extensions also perform an axial movement.

A fluid line coupling according to the invention is also advantageous, in which the unlocking extension of the locking ring and the unlocking member of the locking element each have an actuating surface, wherein the actuating surface of the unlocking extension can be brought into contact with the actuating surface of the unlocking member in order to actuate the unlocking member. The actuating surfaces are preferably aligned facing each other. Preferably, the actuating surfaces are aligned parallel to each other. Preferably, the actuating surfaces are arranged at a distance from one another in the axial direction in the locking state. The actuating surfaces can preferably be brought into contact with one another by an axial movement of the locking ring, in particular the locking part of the locking ring. The actuating surfaces can be brought into full-surface or partial-surface contact.

A fluid line coupling according to the invention is also preferred, in which the unlocking movement of the locking arm can be brought about by an axial movement of the locking ring, wherein the axial movement of the locking ring in the unlocking state preferably causes an unlocking force in the axial direction on the at least one unlocking member of the locking element and/or on the locking arm of the locking element. Preferably, the at least one unlocking extension of the locking ring and the at least one unlocking member of the locking element are arranged at a distance from one another in the locking state. Preferably, the at least one unlocking extension of the locking ring and the at least one unlocking member of the locking element are arranged without a distance from one another in the unlocking state. Preferably, the at least one unlocking extension of the locking ring moves towards the at least one unlocking member of the locking element as a result of the axial movement of the locking ring. The axial movement of the locking ring can, for example, be carried out by user intervention

The unlocking movement of the locking arms can preferably be realized by an unlocking force on the unlocking members, in particular a tensile or compressive force acting on the actuating surfaces, in the axial direction by the axial movement of the locking ring. Preferably, the axial movement takes place along an axial movement path, wherein the axial movement path is preferably a straight line. Preferably, the axial movement path runs parallel to a longitudinal axis of the fluid line coupling. Preferably, the unlocking movement of the locking arms runs along an unlocking movement path. The unlocking movement path can be linear and/or curved, at least in sections. By the unlocking movement the coupling plug is unlocked. In particular, the locking extension of the locking arm is removed from the locking collar of the coupling plug by the unlocking movement in order to release it.

In another preferred embodiment of the fluid line coupling according to the invention, the unlocking movement of the locking arm is a tilting movement of the locking arm along a tilting movement path about a tilting axis. Preferably, the tilting movement is a curved movement of the locking arm along a curved tilting movement path of the locking arm. A torque acting on the locking arm is generated by the unlocking force of the unlocking extension on the unlocking member. The torque acting on the locking arm preferably generates the tilting movement of the locking arm about a tilting axis. The tilting axis preferably runs orthogonally to the longitudinal axis of the fluid line coupling. The tilting axis can also run outside the locking arm. Preferably, the locking arms spread outwards due to the tilting movement of the locking arms so that the coupling plug is unlocked.

A fluid line coupling according to the invention is also advantageous, in which the locking arm has a material thickness which is reduced at least in sections in a bending area, wherein the bending area is elastically deformable by the actuation of the at least one unlocking member for bringing about the unlocking movement of the locking arm. In the bending area, an elastic deformation of the locking arm is caused by the unlocking movement. The bending area with the at least partially reduced material thickness can be arranged at least partially in a connection area of the locking arm to the locking element. By the reduced material thickness in the bending area of the locking arm the unlocking force required for unlocking the fluid line coupling can be reduced. In addition, a required unlocking force can be defined by changing the material thickness in the bending area.

In a further preferred embodiment of the fluid line coupling according to the invention, the fluid line coupling comprises at least one locking indicator which is set up to haptically and/or optically indicate a current locking state and/or unlocking state of the fluid line coupling by elastic deformation. The presence of a locking state and/or unlocking state of the fluid line coupling can preferably be determined from the outside by means of the at least one locking indicator. In particular, the locking state and/or unlocking state of the fluid line coupling can be determined optically, for example by a user or electronically by means of an optical detection device, and/or haptically, for example by a user feeling the locking indicator. Preferably, the fluid line coupling comprises at least two opposing locking indicators.

In a further development of the fluid line coupling according to the invention, the at least one locking indicator is a component of the locking ring and/or the at least one locking indicator can be actuated by means of a locking collar of the coupling plug for indicating the current locking state and/or the current unlocking state. Preferably, the locking ring comprises two opposing locking indicators. Preferably, the locking indicators are arranged in openings of the locking ring. In addition, the locking indicators are preferably firmly connected to the locking ring, in particular in a material-locking manner. Preferably, the locking indicators comprise at least one extension which protrudes into the interior of the locking ring in the unlocking state of the fluid line coupling and/or when the coupling plug is not or not fully inserted. Preferably, the locking indicators are flush with the outer circumference of the locking ring in the unlocking state and/or when the coupling plug is not or not fully inserted. Preferably, the locking indicators are arranged on the locking part of the locking ring. In the locking state and/or when the coupling plug is inserted, the locking indicators protrude at least partially outwards from the locking ring. As the locking indicators protrude outwards, the locking indicators can be seen and/or felt from the outside and the current locking state can be determined optically and/or haptically from the outside.

In the locking state and/or when the coupling plug is inserted, the locking collar of the coupling plug contacts the extension of the locking indicator. Preferably, the locking indicator is pressed radially outwards by the locking socket, in particular through the opening of the locking ring. Preferably, the locking indicator performs a tilting movement as a result of the pressure exerted by means of the locking socket. By the tilting movement the locking indicator is preferably elastically deformed, in particular bended in a bending area of the locking indicator. Preferably, the locking indicator returns to its initial state when the fluid line coupling is moved from the locking state back to the unlocking state and/or when the coupling plug is partially or completely pulled out of the coupling housing.

In the following, preferred embodiments of the invention are explained and described in more detail with reference to the accompanying drawings. Showing:

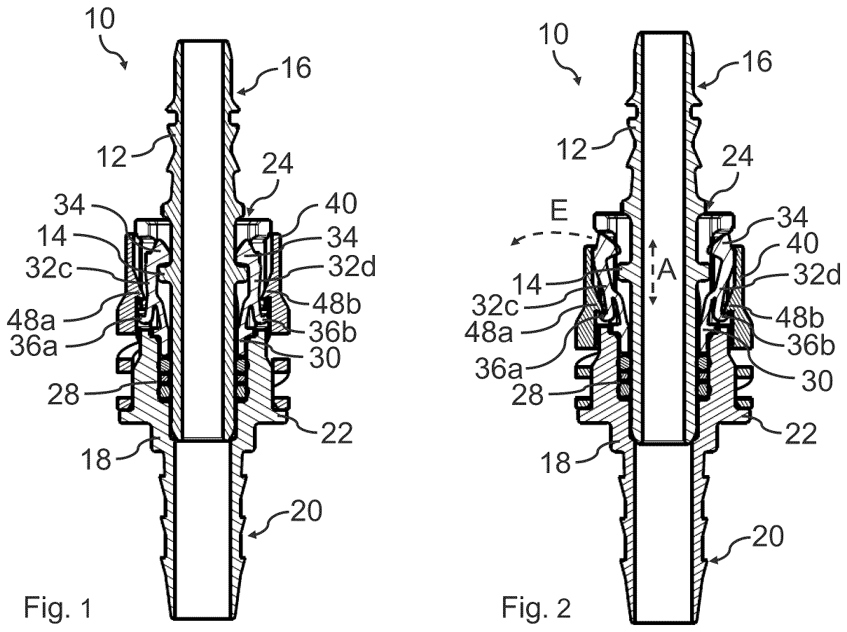

FIG. 1 sectional view of a fluid line coupling according to the invention in the locking state;

FIG. 2 sectional view of the fluid line coupling shown in FIG. 1 in the unlocking state;

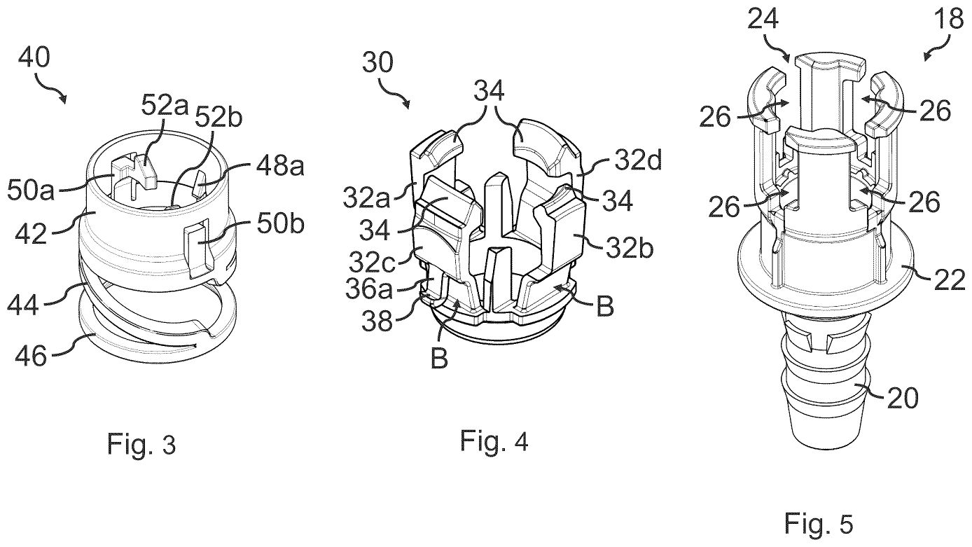

FIG. 3 a locking ring of the fluid line coupling shown in FIG. 1 in a perspective view;

FIG. 4 a perspective view of a locking element of the fluid line coupling shown in FIG. 1;

FIG. 5 a perspective view of a coupling housing of the fluid line coupling shown in FIG. 1;

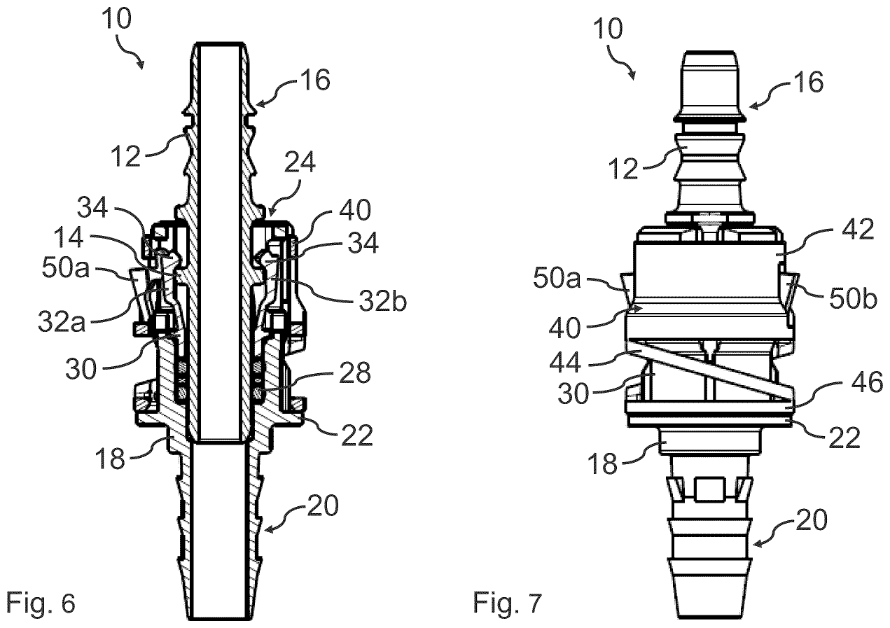

FIG. 6 another sectional view of the fluid line coupling shown in FIG. 1 in the locking state;

FIG. 7 a side view of the fluid line coupling shown in FIG. 1 in the locking state;

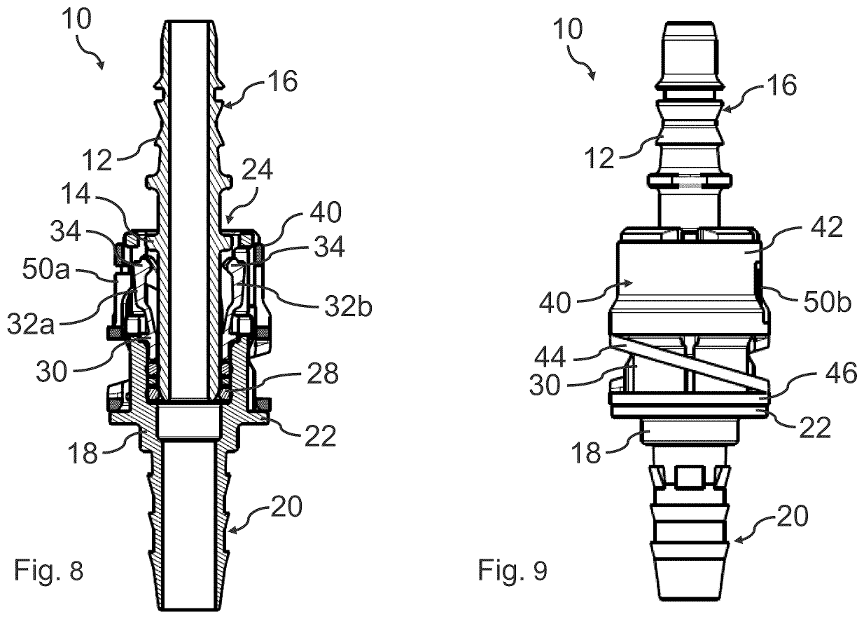

FIG. 8 a sectional view of the fluid line coupling shown in FIG. 1 with the coupling plug not inserted; and

FIG. 9 a side view of the fluid line coupling shown in FIG. 1 with the coupling plug not inserted.

FIG. 1 shows a longitudinal section of a fluid line coupling 10, which comprises a coupling plug 12, a coupling housing 18, a locking element 30 and a locking ring 40. By means of the fluid line coupling 10, fluid lines, in particular hoses and/or pipes, can be connected to one another in a fluid-conducting and reversibly detachable manner. For this purpose, the coupling housing 18 comprises a fluid line receiving area 20 and the coupling plug 12 comprises a fluid line receiving area 16. Seals 28 arranged between the coupling plug 12 and the coupling housing 18 ensure that a flowing fluid cannot escape from the fluid line coupling 10.

In FIG. 1, the fluid line coupling is shown in a locking state, wherein the coupling plug 12, which is fully inserted axially into the coupling housing 18 and extends through an axial opening 24 of the coupling housing 18, is locked inside the coupling housing 18 by means of the locking element 30 and an unlocking is blocked by means of the locking ring 40 pushed over the outside of the coupling housing 18.

The coupling plug 12 comprises a circumferential locking collar 14, wherein the locking element 30 has locking arms 32a-32d extending in the axial direction of the fluid line coupling 10, which in the locking state each have a radially inwardly projecting locking extension 34 engaging over the locking extension 14 of the coupling plug 12, wherein in this way an axial movement A of the coupling plug 12 upwards out of the coupling housing 18 is blocked and the coupling plug 12 is thus locked.

By means of the locking ring 40, unlocking of the coupling plug 12 is prevented in the locking state, wherein an unlocking movement E of the locking arms 32a-32d radially outwards is blocked by the locking ring 40. The locking ring 40 is pushed over the coupling housing 18 from the outside and is supported axially on a support collar 22 of the coupling housing 18.

Furthermore, the locking arm 32c of the locking element 30 has an unlocking member 36a and the locking arm 32d of the locking element 30 has an unlocking member 36b. In addition, the locking ring 40 has two opposing unlocking extensions 48a, 48b. By means of the unlocking extensions 48a, 48b of the locking ring 40, the unlocking members 36a, 36b of the locking arms 32c, 32d can be actuated in order to unlock the coupling plug 12 by means of an unlocking movement E of the locking arms 32c, 32d. In the locking state, the unlocking extensions 48a, 48b of the locking ring 40 are each arranged at an axial distance from the unlocking members 36a, 36b of the locking arms 32c, 32d.

FIG. 2 shows a longitudinal section of the fluid line coupling 10, wherein an unlocking state of the fluid line coupling 10 is shown in FIG. 2. In the unlocking state, the coupling plug 12 is fully inserted into the coupling housing 18, but the locking arms 32c, 32d are in an unlocked position, so that the locking collar 14 of the coupling plug 12 is not blocked by the locking extensions 34 of the locking arms 32c, 32d. In the unlocking state of the fluid line coupling 10, the coupling plug can thus be pulled upwards out of the coupling housing 18 by an axial movement A of the coupling plug 12.

The unlocking state of the fluid line coupling 10 is brought about by an axial movement of the locking ring 40 downwards. When moving from the locking state to the unlocking state, the unlocking extensions 48a, 48b of the locking ring 40 also perform a downward axial movement A due to the downward axial movement A of the locking ring 40, so that the unlocking extensions 48a, 48b actuate the unlocking members 36a, 36b of the locking arms 32c, 32d by the unlocking extensions 48a, 48b exerting a compressive force on unlocking members 36a, 36b

The compressive force on the unlocking elements 36a, 36b generates a torque acting on the locking arms 32c, 32d. The torque acting on the locking arms 32c, 32d in turn results in the unlocking movement E of the locking arms 32c, 32d. The unlocking movement E is a tilting movement of the locking arms 32c, 32d outwards along a curved unlocking movement path about a tilting axis running orthogonally to the axial direction of the fluid line coupling 10, wherein the locking arms 32c, 32d are elastically deformed and spread outwards by the unlocking movement E. The unlocking movement E of the locking arms 32c, 32d brings about the unlocking state shown in FIG. 2, in which the locking arms 32c, 32d are in an outwardly spread unlocked position, so that the locking collar 14 is released and the coupling plug 12 can be removed from the coupling housing 18 by pulling it out upwards through the axial opening 24.

FIG. 3 shows a perspective view of the locking ring 40 of the fluid line coupling 10, wherein the locking ring 40 comprises a locking part 42, a spring part 44 and a support part 46. By means of the locking part 42, an unlocking movement E of the locking arms 32a-32d of the locking element 30 is blocked in the locking state. In the assembled state of the fluid line coupling 10, the support part 46 rests on the support collar 22 of the coupling housing 18. The spring part 44 enables an axial movement A of the locking part 42 by springing together the spring part 44.

The locking ring 40 also comprises two oppositely arranged unlocking extensions 48a, 48b, which are hook-shaped and are arranged on the inner circumference of the locking part 42 aligned obliquely in the direction of the spring part 44 of the locking ring 40, wherein the unlocking extensions 48a, 48bcomprise an actuating surface 30 (not shown) for actuating the unlocking members 36a, 36b of the locking element 30. By means of the axial movement A of the locking part 42, the unlocking extensions 48a, 48bare also moved in the axial direction, so that the unlocking members 36a, 36b of the locking element 30 are actuated by means of the unlocking members 36a, 36b of the locking element 30 to bring about the unlocking movement E by means of the axial movement A.

Furthermore, the locking ring 40 comprises two locking indicators 50a, 50b arranged opposite each other and inside the locking part 42, each of which has an extension 52a, 52b. By means of the locking indicators 50a, 50b, a current locking state and/or unlocking state of the fluid line coupling 10 can be recognized haptically and optically from the outside. By means of the locking collar 14 of the coupling plug 12, the locking indicators 50a, 50b are elastically pressed radially outwards out of the locking part 42 of the locking ring 40 by pressure on the extensions 52a, 52b, so that the locking indicators 50a, 50b project beyond the outer circumference of the locking ring 40 and can be seen and felt from the outside when the coupling plug 12 is fully inserted and/or locked in the coupling housing 18.

FIG. 4 shows the locking element 30 of the fluid line coupling 10. The locking element 30 has four locking arms 32a-32d, each with a locking extension 34, and is arranged inside the coupling housing 18 when the fluid line coupling 10 is assembled. The locking arms 32a, 32b and the locking arms 32c, 32d are each arranged opposite one another and are evenly distributed over the circumference of the locking element 30. By means of the locking element 30, the coupling socket 12 is locked within the coupling housing 18 by the locking extensions 34 blocking the locking collar 14 of the coupling socket 12 and thus preventing the coupling socket 12 from moving out of the coupling housing 18.

In addition, the oppositely arranged locking arms 32c, 32d each comprise an unlocking member 36a, 36b, wherein the unlocking members 36a, 36b are each arranged on the outside of the respective locking arm 32c, 32d, which face the locking ring 40 in the mounted state. The unlocking members 36a, 36b are designed as hook-shaped extensions of the locking arms 32c, 32d, which each have a section extending radially outwards. The radially outwardly extending section of the unlocking members 36a, 36b comprises an actuating surface 30, which in the assembled state are directed in the direction of the unlocking extensions 48a, 48b of the locking ring 40 and are set up to be brought into contact with the unlocking extensions 48a, 48b of the locking ring 40 by the axial movement A of the locking part 42 of the locking ring 40 to bring about the unlocking movement E in the unlocking state of the fluid line coupling 10

When the unlocking members 36a, 36b are actuated, a moment acts on the locking arms 32c, 32d so that these are each bent elastically in a bending area B and consequently execute the unlocking movement E in order to release the locking of the coupling plug 12. In the bending area B, the material thickness of the locking arms 32a-32d is reduced compared to the other areas of the locking arms 32a-32d. Due to the reduced material thickness in the respective bending areas B of the locking arms 32c, 32d, a force required to bring about the unlocking movement E is reduced when the unlocking members 36a, 36b are actuated, since elastic deformation of the locking arms 32c, 32d is facilitated.

FIG. 5 shows a perspective view of the coupling housing 18 of the fluid line coupling 10. The coupling housing 18 is designed as an axially extending cylindrical hollow body and has an axial opening 24 on its upper side. The locking element 30 and the coupling socket 12 can be inserted axially into the coupling housing 18 through the axial opening 24. In the inserted state of the locking element 30 in the coupling housing 18, the locking arms 32a-32d of the locking element 30 engage in radial openings 26 of the coupling housing 18, so that the locking element 30 cannot slip out of the coupling housing 18 unintentionally. The radial openings 26 of the coupling housing 18 are evenly distributed over the circumference of the coupling housing 18 and are shaped in such a way that the locking arms 32a-32d of the locking element 30 can extend radially through them, at least in sections.

Also a fluid line receiving area 20 for connecting a fluid line to the coupling housing 18 extends on the underside of the coupling housing 18. For example, an elastic hose can be pushed over the fluid line receiving area 20 so that it is connected to the coupling housing 18 in a fluid-conducting manner. In addition, the coupling housing 18 comprises a circumferential support collar 22, on which the locking ring 40 is supported by its support part 46 in the assembled state. For this purpose, the locking ring 40 is pushed over the outer circumference of the coupling housing 18 until it strikes against the support collar 22 of the coupling housing 18 with the support part 46.

FIG. 6 and FIG. 7 show the fluid line coupling 10 in the locking state with the coupling plug 12 fully inserted and locked. FIG. 6 shows the fluid line coupling 10 in a sectional view rotated by 90 degrees in contrast to FIG. 1 and FIG. 2. FIG. 7 shows the fluid line coupling 10 in a side view from the outside in the same orientation as in the sectional view in FIG. 6.

The fluid line coupling 10 is in the locking state, in which the locking collar 14 of the coupling plug 12 is locked by means of the locking extensions 34 of the locking arms 32a-32d. By means of the locking indicators 50a, 50b of the locking ring 40, it can be recognized optically and haptically from the outside that the coupling plug 12 is fully inserted into the coupling housing 18. The locking indicators 50a, 50b each comprise an extension 52a, 52b projecting radially into the interior of the coupling housing 18, wherein the extensions 52a, 52b are contacted by the locking assembly 14 of the coupling plug 12, so that the locking indicators 50a, 50b are pressed elastically radially outwards by a tilting movement. Because the locking indicators 50a, 50b are pressed outwards, they protrude visibly and perceptibly beyond the outer circumference of the locking ring 40 pushed over the clutch housing 18, so that the complete insertion of the coupling plug 12 into the coupling housing 18 can be detected optically and haptically from the outside.

FIG. 8 and FIG. 9 show the fluid line coupling 10 with the coupling plug 12 not fully inserted in a sectional view and in a side view in the same orientation as in FIG. 6 and FIG. 7.

The fluid line coupling 10 is not locked, since the coupling plug 12 is not fully inserted into the coupling housing 18 and the locking collar 14 of the coupling plug 12 is correspondingly not locked by means of the locking extensions 34 of the locking arms 32a-32d. By means of the locking indicators 50a, 50b of the locking ring 40, it is optically and haptically recognizable from the outside that the coupling plug 12 is not fully inserted into the coupling housing 18, since the extensions 52a, 52b are not contacted by the locking collar 14 of the coupling plug 12, so that the locking indicators 50a, 50b are flush with the outer circumference of the locking ring 40 and do not protrude outwards. In this way, it is optically and haptically recognizable from the outside that the coupling plug 12 is not fully inserted into the coupling housing 18 and is therefore not locked.

### LIST OF REFERENCE SYMBOLS

10 Fluid line coupling
12 Coupling plug
14 Locking collar
16 Fluid line receiving area
18 Coupling housing
20 Fluid line receiving area
22 Support collar
24 Axial opening
26 Radial openings
28 Seals
30 Locking element
32a-32d Locking arms
34 Locking extensions
36a, 36b Unlocking members
38 Actuating surface
40 Locking ring
42 Locking part
44 Spring part
46 Support part
48a, 48b Unlocking extensions
50a, 50b Locking indicators
52a, 52b Extensions
A Axial movement
B Bending area
E Unlocking movement

1. Fluid line coupling (10) for the reversibly detachable connection of fluid lines, with
a coupling plug (12),
a locking element (30), which comprises at least one locking arm (32a-32d) with at least one locking extension (34) for locking the coupling plug (12) in a locking state of the fluid line coupling (10),
a coupling housing (18), wherein the locking element (30) and the coupling plug (12) are arranged at least partially in the coupling housing (18) in the locking state of the fluid line coupling (10), and
a locking ring (40), by means of which an unlocking movement (E) of the locking arm (32a-32d) is blocked in the locking state of the fluid line coupling (10), characterized in that the locking element (30) has at least one unlocking member (36a, 36b), wherein the unlocking movement (E) of the locking arm (32a-32d) in an unlocking state of the fluid line coupling (10) can be brought about by an actuation of the at least one unlocking member (36a, 36b) by means of the locking ring (40).

2. Fluid line coupling (10) according to claim 1, characterized in that the at least one unlocking member (36a, 36b) is arranged on the locking arm (32a-32d).

3. Fluid line coupling (10) according to claim 1 or 2, characterized in that the at least one unlocking member (36a, 36b) is designed as a hook-shaped extension, wherein the at least one unlocking member (36a, 36b) preferably extends at least in sections in the radial direction of the locking element (30).

4. Fluid line coupling (10) according to one of the preceding claims, characterized in that the locking ring (40) comprises at least one unlocking extension (48a, 48b) for actuating the at least one unlocking member (36a, 36b) of the locking element (30) in the unlocking state of the fluid line coupling (10).

5. Fluid line coupling (10) according to claim 4, characterized in that the unlocking extension (48a, 48b) of the locking ring (40) and the unlocking member (36a, 36b) of the locking element (30) each have an actuating surface (38), wherein the actuating surface (38) of the unlocking extension (48a, 48b) can be brought into contact with the actuating surface (38) of the unlocking member (36a, 36b) in order to actuate the unlocking member (36a, 36b).

6. Fluid line coupling (10) according to one of the preceding claims, characterized in that the unlocking movement (E) of the locking arm (32a-32d) can be brought about by an axial movement (A) of the locking ring (40), wherein the axial movement (A) of the locking ring (40) in the unlocking state preferably causes an unlocking force in the axial direction on the at least one unlocking member (36a, 36b) of the locking element (30) and/or on the locking arm (32a-32d) of the locking element (30).

7. Fluid line coupling (10) according to one of the preceding claims, characterized in that the unlocking movement (E) of the locking arm (32a-32d) is a tilting movement of the locking arm (32a-32d) along a tilting movement path about a tilting axis.

8. Fluid line coupling (10) according to one of the preceding claims, characterized in that the locking arm (32a-32d) has a material thickness which is reduced at least in sections in a bending area (B), wherein the bending area (B) is elastically deformable by the actuation of the at least one unlocking member (36a, 36b) for bringing about the unlocking movement (E) of the locking arm (32a-32d).

9. Fluid line coupling (10) according to one of the preceding claims, characterized in that the fluid line coupling (10) comprises at least one locking indicator (50a, 50b) which is set up to haptically and/or optically indicate a current locking state and/or unlocking state of the fluid line coupling (10) by elastic deformation.

10. Fluid line coupling (10) according to claim 9, characterized in that the at least one locking indicator (50a, 50b) is a component of the locking ring (40) and/or can be actuated by means of a locking collar (14) of the coupling plug (12) for indicating the current locking state and/or the current unlocking state.
